(19) United States
(12) Patent Application Publication
(10) Pub. No.: US 2010/0249995 A1
(43) Pub. Date: Sep. 30, 2010

(54) Method and Apparatus for Online Procurement of Chemical Screening Assays

(75) Inventors: Roger O. Williams, Paradise Valley, AZ (US); Ronald D. Jones, San Jose, CA (US); Charles A. Reichel, Fremont, CA (US); Gregory B. Stephens, Cupertino, CA (US); Michael J. Forbush, Hollister, CA (US)

Correspondence Address: DONALD J. PAGEL, 586 NORTH FIRST STREET, SUITE 207, SAN JOSE, CA, 95112, US

(73) Assignee: CHEMPRINTCO, LLC, Milpitas, CA (US)

(21) Appl. No.: 12/416,079

(22) Filed: Mar. 31, 2009

(51) Int. Cl. G06F 17/00; G06Q 30/00; G06Q 50/00

(52) U.S. Cl. 700/233; 705/27

(57) ABSTRACT

A method and apparatus for ordering a preloaded chemical assay plate. The method comprises the steps accessing an Internet based order entry site; viewing a list of target chemical compounds; creating an order on the order entry site that lists the desired target compounds for the assay; specifying one or more well plate parameters, such as the number of wells in a well plate that will be used to hold the target compounds; specifying one or more assay parameters in the order, such as specifying the final test volume and concentration of the target compounds in the wells; and placing the order from the order entry site. The apparatus comprises a server for accepting the customer order transmitted over the Internet; a storage means for electronically storing the list of target compounds; process control means for generating a work order that contains instructions for retrieving one or more working plates that contain the chemical compounds specified in the customer order; and assay printing means for acoustically dispensing the chemical compounds onto the assay substrate.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO A SEQUENCE LISTING

Not Applicable

### BACKGROUND OF THE INVENTION

The screening of large numbers of chemical compounds for pharmaceutical, toxicological, genetic or other types of activity is a technique that is widely used by scientists and researchers. For example, in searching for compounds that might have usefulness as new drugs (commonly referred to as hits), a researcher may want to determine if a compound shows any sign of binding to or reacting with another biological molecule, so as to decrease or increase the activity of the biomolecule. To do this, the researcher may want to use a process, such as a high throughput screening process, to evaluate how one or more test compounds react with tens or hundreds of thousands of target compounds. In one type of high throughput screening process, a small volume of each target compound is placed in the well of a well plate, and a small volume of an individual test compound is then added to each well. Various analytical techniques are then employed to determine if a reaction has occurred between each pair of test and target compounds.

Because of the large number of compounds being tested in such assays, automated liquid dispensing and handling techniques are usually utilized in the process to save time and increase the accuracy of the assay. Additionally, many times a researcher can purchase the target compounds from a commercial supplier, thereby eliminating the need for the researcher's lab to synthesize the tens or hundreds of thousands of target compounds that are used in the assay. For example, the commercial supplier Peakdale Molecular sells a screening library of over 6,500 compounds designed to evaluate G-Protein Coupled Receptor (GPCR) activity, and Sigma-Aldrich has a library of shRNA gene targets available for purchase. Other commercial suppliers, such as ChemBridge Corporation, provide other types of chemical and biomolecule libraries. However, a number of practical problems hamper the use of these high throughput screening process techniques.

One problem is the cost of the target compounds. Because the commercial supplier has expenses to consider in making large numbers of target compounds available for sale, the commercial supplier may want to sell the target compounds in relatively large quantities. Additionally, the commercial supplier may prefer to sell a complete library of target compounds, even though the researcher is only interested in part of the library. This means that purchasing the necessary target compounds is a significant expense for the researcher, especially for a researcher who only wants to run a limited number of assays. A related problem is that the researcher may have to purchase target compounds or libraries of compounds from more than one commercial supplier in order to construct the desired assay, an issue that further increases the costs involved. An additional problem is the preparation of the assay plates. Even with automated liquid handling equipment, a lab worker must spend time setting up, preparing and monitoring the transfer of thousands of target compounds from stock solutions into the wells of the assay plate.

What is needed is a quick and inexpensive way to allow a researcher to design an assay from the full range of commercially available target compounds, that uses only the quantities and specific target compounds that are of interest to the researcher, and to receive this custom designed assay in a format that is nearly ready for use.

### SUMMARY OF THE INVENTION

Briefly, the present invention comprises a method and apparatus for ordering a single use chemical assay plate that is preloaded with the specific target compounds selected by the scientist/researcher end user. The order is placed on a website that allows the end user to view a list containing thousands or hundreds of thousands of target compounds made available by a number of commercial suppliers. For example, the target compounds may include (but are not limited to) any type of chemical used in assays associated with drug discovery, compound efficacy, drug toxicity, protein-protein interaction, cell-based assays, rapid PCR (polymerase chain reaction) assays, and RNAi (RNA interference) screens.

The order specifies which target compounds the end user wants in the assay, and compound filters are provided to assist the end user in selecting the target compounds to be used in the assay. The end user can also select a number of well plate parameters that specify the type of well plate that should be used in the assay, such as the well plate density (number of wells) and material, and the final test concentration and volume in each well. The end user can also specify which wells are used for target compounds and which wells are left empty for controls, as well as a number of other details relating to the design of the assay. The completed single use chemical assay plate is then packaged and mailed to the end user.

The apparatus used for supplying the chemical assay plate comprises a server for accepting the customer order transmitted over the Internet; a storage means, such as a data base, for electronically storing the list of target compounds available for inclusion in the customer order; process control means, such as a laboratory information management system (LIMS) system, for generating a work order that contains instructions for retrieving one or more working plates that contain the chemical compounds specified in the customer order; and assay printing means, such as an acoustic liquid dispensing apparatus for dispensing the chemical compounds onto the assay substrate in volumes that are generally in the range of 10-250 nL.

### BRIEF DESCRIPTION OF THE SEVERAL VIEWS OF THE DRAWINGS

FIG. 1 is a flow chart of a method according to the present invention;

FIG. 2 is a flow chart of a method according to the present invention; and

FIG. 3 is a block diagram of an apparatus according to the present invention.

### DETAILED DESCRIPTION OF THE INVENTION

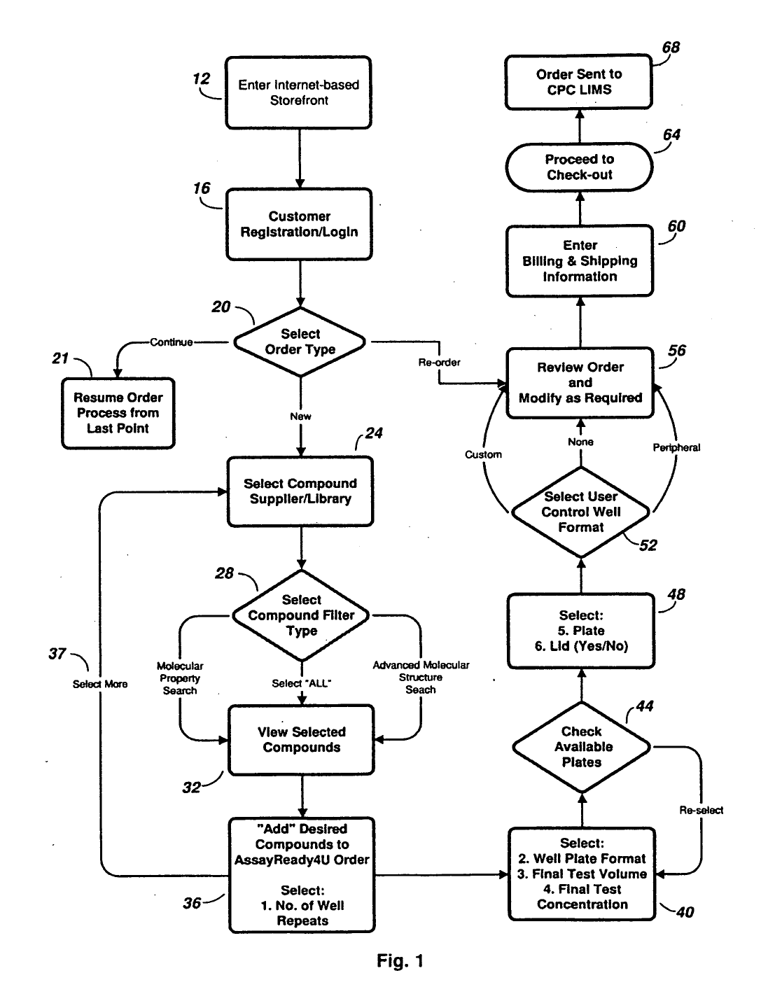

FIG. 1 illustrates the method for using an online portal (also called an Internet store front) to assemble a chemical assay. In step 12, the user/customer accesses the online portal such as by accessing a web site over a global information network like the Internet. In step 16 (optional), the user provides registration and/or login information, such as a user identification code (user ID) and/or a password. There are many types of information that can be provided during step 16, the general purpose of which is to identify or verify the identity of the user/customer for administrative and/or security reasons. In some situations, step 16 can be skipped.

In step 20 (optional), the user specifies the type of order that is being placed, such as a new order, a repeat of a previous order (i.e. a reorder), or a continuation of a previously saved order. If the new order option is selected, the order process continues to step 24. If the reorder option is selected, the order process skips to a review step such as step 56. If the continue option is selected, the order process resumes at the step where the user previously ended and stored the order, as is indicated by step 21. In alternative embodiments, some or all of the options in step 20 could be deleted or changed.

Steps 24, 28, 32 and 36 are used to specify the chemical composition of the assay the user wants to build. In step 24, the user selects the supplier of the chemical compounds that the user wants to use in the composition of the assay and/or the library of compounds the user is interested in. For example, in step 24 a drop down menu will display one or more suppliers A, B and C who are all commercial suppliers of chemical compounds. Clicking on one of the suppliers presents an additional menu of the chemical compounds and/or libraries of compounds that are provided by that supplier, and that can be used as a preliminary selection of chemicals. For example, supplier A may offer a particular library of compounds, library A, that is of interest to the user. By selecting library A, the user adds all of the chemicals in library A to the user's preliminary selection.

In step 28, the user has the option of applying a filter to the preliminary selection made in step 24 to yield a modified preliminary selection of chemical compounds. The filter selects only the chemical compounds that meet the criteria specified by the filter. In a preferred embodiment, three types of filters are available in step 28: a molecular property search filter; an advanced molecular structure search filter; and a select all search filter. The molecular property search filter filters the group of chemical compounds so that only the chemical compounds having the specified molecular property/properties will be selected. Examples of molecular properties include, but are not limited to, hydrogen bonding, molecular weight and polar surface area, etc. A particularly useful configuration for the molecular property search filter is to select compounds that satisfy the “Lipinski Rule of Five” criteria that predict the likelihood that a molecule will have drug-like properties. The advanced molecular structure search filter selects compounds from the preliminary selection that have a specified molecular substructure or functional group, such as a benzene ring. The select all filter selects all of the chemical compounds displayed in the preliminary selection made in step 24. In other embodiments, other types of filters could be used to aid in the selection of chemical compounds from a library or database. For example, an alpha sort filter could be used to sort a group of chemical compounds by the common names given to the compounds, or a supplier ID filter could be used that sorts a group of chemical compounds by the unique number that a supplier assigns to each compound. Similarly, filters that select compounds having particular three-dimensional shapes or topological features could be used.

In step 32, the modified preliminary selection of chemical compounds is displayed for review by the user. The modified preliminary selection is a list of the chemical compounds in the preliminary selection that remain after the filtering process from step 28 has been applied to the preliminary. In step 36, the user selects which of the compounds displayed in the modified preliminary selection from step 32 are to be present in the assay. In other words, in step 36 the user has the option of selecting some or all of the compounds displayed in step 32. Also, in step 36 the user specifies how many well repeats should be present in the assay. In the assay, each chemical is dispensed into a separate well in a well plate. Well repeats refers to the number of wells in the well plate that each chemical should be dispensed into. In some cases, a selected chemical is only dispensed into one well. In other cases, the user will choose to have a chemical dispensed into two or more wells. For example, the user may choose to have each compound dispensed into four (4) wells, giving the user a 4-times (4×) redundancy for the assay.

Additionally, in step 36 the user can sometimes return to step 24 to select a new/different compound supplier or library to use for selecting compounds, as is indicated by line 37. After a new/different compound supplier or library is selected, steps 28, 32 and 36 may be repeated to add compounds to the previously generated list. In some embodiments, only chemical compounds from a single chemical supplier can be selected in step 36, so the option of using line 37 is not available. In other embodiments, chemical compounds from more than one chemical supplier can be chosen, so the option of using line 37 is available.

Once the chemical compounds for the assay have been selected (steps 24, 28, 32 and 36), the type and configuration of the well plate is selected. In step 40, one or more well plate parameters are selected to set the type and configuration of the well plate. In a preferred embodiment the well plate parameters include the well plate format, the final test volume and the final test concentration. Other well plate parameters, such as the well plate material and the well plate manufacturer may be specified. The well plate format parameter specifies which industry-standard well plate density the user desires his assay to be formatted in. In a preferred embodiment, the user may select from 96, 384, 1536 and 3456 well plate densities (density meaning the number of wells contained on each well plate). The well plate format parameter may also include the material from which the well plate is comprised. In other words, when selecting the well plate density, the user may also specify a well plate material, such as polypropylene, polystyrene or cyclo olefin copolymer.

Additionally, the well plate format parameter may include specifying which chemical compound should be placed in which well or wells (called well location). The well location includes the row and column numbers for the well on the well plate. Specifying the well location is an optional step. If the user does not specify the well location, then by default the well plate will be filled in an “optimal” sequence. In a preferred embodiment, the optimal sequence means the easiest, fastest, sequential order.

In general, the optimal sequence is related to how the various chemical compounds are stored prior to building an assay well plate. Typically, all of the compounds are in what are called “working plates.” Based upon what is selected by the user, the proper working plates are loaded into the dispenser (see FIG. 3). The first working plate is loaded and the first desired compound is dispensed. The working plate is then indexed to the next desired compound and it is dispensed. And so on until all of the desired compounds in the first working plate are dispensed. The next working plate is selected and the process continues. The process of selecting working plates continues until all desired compounds have been dispensed. In some cases, many of the desired compounds can be in one working plate, with only a few compounds in the following working plate or plates.

The final test volume is the total volume of the chemical compound in the well plus any other liquids that are added to the well, such as solvents and/or buffers, etc., just before the end user runs the assay. The well plate selected in steps 44 and 48 must have sufficiently large wells to accommodate the final test volume. The final test concentration is the concentration of the chemical compound in the well just before the end user runs the assay. So, the final test concentration is the concentration of the chemical compound after the user has “back filled” the well with whatever other liquid they have chosen. The ratio of compound volume dispensed by the operator to what the user's back fill volume is could be 1:10, or 1:100, or 1:1000, or more, or anywhere in between, meaning, for every 1 nL of compound the operator dispenses, the end user will dispense into the same well 10 nL, or 100 nL, and so on.

In alternative embodiments, instead of specifying the final test concentration and final test volume, a parameter related to the final test concentration and/or to the final test volume could be used. The use of a parameter related to the final test concentration and/or to the final test volume is not preferred because it is a more complicated and costly process. A parameter related to the final test concentration means a concentration parameter from which the final test concentration can be calculated. So for example, the actual concentration of the target compound dispensed into the well by the operator could be specified. Then the end user would have to calculate the volume of backfill to yield the final test concentration desired by the end user. Similarly, the parameter related to the final test volume means a volume parameter from which the final test volume can be calculated.

In step 44, a drop down menu displays the well plates that are available to accommodate the three well plate parameters selected in step 40. When choosing a well plate in step 44, the user sees a selection of plates based upon the criteria he entered in step 40. When the user highlights a selection, all of the properties/features of that particular plate are shown. These properties include: the manufacturer, the manufacturer's ID/part number, the material, the number of wells, the shape of the wells (round or square), any special surface treatmnent of the plate, and whether or not the plate is “sterile.” If the available plates are not satisfactory, the user can return to step 40 and edit one or more of the three well plate parameters. After the availability of an acceptable well plate has been determined, in step 48, the user selects the well plate for use in the assay. The user then specifies whether or not lids are desired to cover the wells. It should be noted that throughout the process of building the assay, many of the steps shown in FIG. 1 could be performed in a different order.

In step 52, the user specifies which wells (if any) should be left empty, for example to be used as control wells by the user. In a preferred embodiment, there are three standard selections for the control well format in step 52: none, meaning no empty wells will be left on the well plate for use as controls; peripheral, meaning all of the wells around the perimeter of the well plate will be left empty; and custom, which allows the user to select which wells are to be left blank for control wells. The custom option is achieved by using a pointing device (e.g. a mouse) to select the wells on a map of the well plate map shown on a web page (i.e. on the Internet based storefront). In step 56, the order is displayed for review by the user. The order can be modified at this point, if required, by returning to any of the previous steps. Step 56 is also the point (e.g. webpage) to which the user will be directed if the reorder option is selected in step 20. In this case, a previous order specified by the user will be displayed in step 56.

In step 60, the user/customer's billing and shipping information is entered. The billing information could include an account number to be billed, a reference to a company purchase order number, or a credit card number. The shipping information would include an address for the assay plate(s) to be shipped to, as well as any special shipping instructions. In step 64, the user places the order by accessing a check out screen and placing/confirming the order, at which time the user's account is charged for the order. In step 68, the order placed in step 64 is sent to an automated order processing module, such as a laboratory information management system (LIMS) system, which initiates a process that fills the order.

In a preferred embodiment, the process illustrated in FIG. 1 is implemented in software that runs on a server accessible over the Internet (such as the server 124 in FIG. 3). Preferably, the end users accesses a website that gives the end user access to the process, and each of the steps in FIG. 1 are presented to the end user as separate screens or pages of the website.

In a preferred embodiment, the process illustrated in FIG. 1 can be described as a method for ordering a chemical assay plate that comprises the steps of accessing an Internet based order entry site (step 12); viewing a list of chemical compounds accessed from the order entry site, the list comprising a plurality of chemical compounds (steps 24, 28 and 32); creating an order on the order entry site, the order being comprised of one or more assay compounds, the assay compounds comprising one or more chemical compounds selected from the list (step 36); specifying a first well plate parameter in the order that specifies the number of wells in a well plate that will be used to hold the assay compounds (step 40); specifying a second well plate parameter in the order that is related to the final test concentration of at least one of the assay compounds in a solution that is deposited in at least one of the wells (step 40); and placing the order from the order entry site (step 64). The term related to the final test concentration includes parameters such as the final test concentration itself or another concentration parameter from which the final test concentration can be calculated. Similarly, the term related to the final test volume includes parameters such as the actual final test volume itself, or another volume parameter from which the final test volume can be calculated. In the preferred embodiment, the final test concentration and final test volume are used, and typically the final test concentration of each assay compound in an assay well plate is the same, and the final test volume of each assay compound in an assay well plate is the same. Additionally, the second well plate parameter preferably specifies that the final test concentration be in the range of 1 to 50 μM (micromolar) or less.

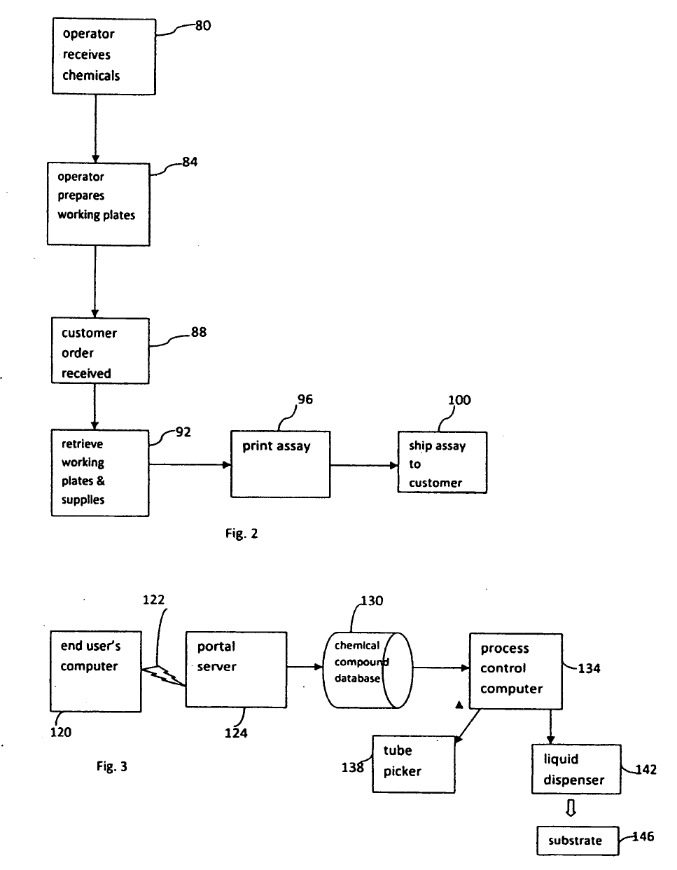

FIG. 2 illustrates the method used for processing and filling an order for a chemical assay and for managing the inventory of chemical compounds that are available for use in the chemical assay. In step 80 of FIG. 2, the operator of the customized assay assembly system receives chemical compounds from one or more suppliers of chemical compounds. Typically, the amount of a chemical compound received in step 80 is a bulk amount, meaning that the quantity of the chemical received by the operator (whether in liquid or solid form) is greater than the quantity that an end user would typically want to purchase for a particular assay. Also, for liquid solutions, the concentration (moles) will typically be much higher (10-100 times higher) than what the end-user/customer will typically purchase as the final test concentration.

In step 84, the operator creates working plates of the chemical compounds. Working plates are just containers to which selected amounts of the bulk chemicals have been transferred. These containers are called working plates because well plates are preferentially used for this purpose. Well plates are convenient containers to store the chemical compounds in and to work with later when preparing assay plates, but other types of containers could be used as working plates. Before preparing the working plates, the operator may have to process the bulk chemical compounds, such as by preparing a stock solution of a solid compound. The operator may also have to process liquid chemical compounds, such as by reducing the stock solution concentration to a more suitable working concentration, for example in the range of 5-10 mMol (milli-Molar). After the working plates have been prepared, they are typically stored in a manner that prevents or retards deterioration or contamination of the chemical compounds, such as by using a protective atmosphere, a protective covering, reduced lighting and/or cooling, etc. In the preferred embodiment, step 84 occurs before step 88. However, in other embodiments the chemicals from step 80 can be stored until after an order is received in step 88, and then step 84 is performed.

In step 88, an order for an assay is received by the operator. In the preferred embodiment, the order is received from the Internet based storefront discussed previously with respect to step 68 in FIG. 1. However, the order could be received in many different ways such as by e-mail, by telephone, on paper such as a written order that is mailed, faxed or delivered by courier, etc. In step 92, after the order for an assay has been received, the working plate or plates containing the chemical compounds requested in the order are retrieved. Additionally, if the order specified other materials, such as a specific type of well plate, these materials will be retrieved from inventor in step 92.

In step 96, the assay is prepared (printed) according to the instructions on the order received in step 88. This means that very small volumes of liquids must be transferred from the working plates onto the customer specified assay substrate (e.g. assay well plate). These small volumes (called dispense volumes) are typically in the range of 1.0 nanoliter (nL) to 500 nL, but can also be as small as 10 picoliters (pL) or larger than 500 nL. Preferably, the dispense volumes transferred from the working plates to the assay well plate are in the range of 10-250 nL, and more preferably are in the range of 15-100 nL. Additionally, the final test concentration is in usually in the range of 1 to 50 μM (micromolar) or less, and the final test volume is related to the size of the wells in the well plate, and hence to the well plate format.

Typically, the volume of liquid dispensed into the assay plate (i.e. the dispense volume) depends on the stock concentration of the compound being requested, the final test concentration and the final test volume requested by the end user. For example, the dispense volume (V_{d}) is given by the formula:

V_{d}=(final test concentration/stock concentration)×final test volume

So, for a stock concentration of 10,000 μM, a final test concentration of 10 μM and a final test volume of 45 μL, the dispense volume is 45 nL.

For practical reasons, volumes less than approximately 100 nL can only be transferred accurately using a machine that dispenses small volumes. Additionally, since the number of transfers from the working plates to the assay plates can range from a hundred transfers to tens or hundreds of thousands or more transfers, and contamination must not be introduced during these transfers, a machine is required to perform the dispensing operation involved in step 96. In the preferred embodiment, the small volume dispenser is an acoustic liquid transfer device, such as the devices described in U.S. Pat. No. 6,596,239 or U.S. Pat. No. 6,863,362.

In step 100, the completed assay substrate, such as a well plate, is shipped to the customer. Generally, the completed assay substrate is packaged so as to avoid contamination or deterioration of the chemicals, and the delivery is done by an overnight delivery service.

The chemical compounds received by the operator in step 80 may comprise any type of chemical that can be handled in an ordinary laboratory environment. However, in a preferred embodiment, the chemical compounds comprise organic chemicals, such as those that are used in pharmacological, medicinal, toxicological, genetic or other types of biochemical research and development. For example, the chemical compounds may include any type of chemical used in assays associated with drug discovery, compound efficacy, drug toxicity, protein-protein interaction, cell-based assays, rapid PCR (polymerase chain reaction), and RNAi (RNA interference) screens.

The chemical compounds received in step 80 generally are supplied to the operator by commercial suppliers of chemicals, such as specialty chemical manufacturers like Sigma Aldrich or Peakdale Molecular. However, the chemical compounds could come from any source, such as university research labs, private labs, government labs, hospitals etc. Furthermore, the chemical compounds could be supplied by any number of suppliers, with several suppliers being preferable to a single supplier, and more suppliers being preferable to fewer suppliers. The greater the number of suppliers, the more choices the customer/end user will have in designing the assay order that is provided in step 88 (and which was designed in steps 24, 28, 32 and 36 of FIG. 1).

Oftentimes, the chemical compounds provided by the supplier in step 80 are in the form of chemical libraries containing hundreds or thousands of chemicals that the supplier has grouped together based on proprietary, industry or research standards or protocols. For example, the peakexplorer™ library offered by Peakdale Molecular, is a library comprised of approximately 6572 organic chemical compounds that show activity in binding to G-protein coupled receptors (GPCRs). Therefore, in conjunction with step 80, the operator enters a list of the chemical compounds into inventory so as to know what chemicals are available for filling customer orders and what quantities of the chemicals are available. In a preferred embodiment, an electronic database of the chemicals is created and the inventory of chemicals is managed using commercially available MRP (material requirement planning) software, or more preferably, commercially available laboratory information management system (LIMS) software.

As mentioned previously, the amount of a chemical compound received in step 80 is a bulk amount, meaning that the amount of the chemical received by the operator is greater than the amount that an end user would want to purchase for a particular assay. The actual weight or volume of a bulk amount can vary widely. However, for complex biochemical compounds, a bulk amount of a single complex liquid chemical compound might be on the order of 250 microliters (μl), and the single liquid compound would be provided to the operator in the well of a well plate, such as a well plate having a ninety-six wells (96 well format). For solid (dry) chemical compounds, a bulk amount of a complex solid compound might be on the order of 0.5 milligrams (mg), and would be provided to the operator in a container such as a vial. These figures for bulk amounts of compounds, and the types of containers, are exemplary only. Other amounts and/or types of containers could be used in the present invention. Typically, the compound supplier will pre-weigh an exact amount of dry compound and put it in a tube or well of a 96-well plate. The supplier provides information to the operator with the exact amount of solvent/reagent to add in order to achieve a suitable concentration (typically on the order of 10 milli-Molar).

For solid compounds, the operator then prepares the solution of the dry compound as described above, using an appropriate solvent/reagent. A working plate is then created by adding the solution of the previously dry compound to the wells of a well plate. For purposes of automation, it is desirable for all of the working plates to be well plates having the same number of wells and a uniform volume of liquid in the wells. Thus, in a preferred embodiment well plates having 1536 wells are used as working plates with 2.5 μl of liquid in each well. In the preferred embodiment, 1536-well well plates made of COC material with a thin-film bottom are used. These well plates work well in the preferred acoustic dispensing machine. Furthermore, using 1536 plates allows the loading of an entire library of compounds (approx. 25,000 compounds) into one acoustic device for creating the user's assay plates. Much larger libraries can be tied to the acoustic dispenser using standard, commercially available automation and well plate handling robotics.

Therefore, the solutions made from solid compounds are stored in 1536 well working plates, and any bulk liquid compounds that were provided in containers or well plates other than well plates having 1536 wells, are transferred to 1536 well working plates having 2.5 μl of liquid in each well. A liquid transfer apparatus, such as the Bravo™ (available from Velocity 11) liquid pipettor, is used to make transfers from well plates having 96 wells to well plates having 1536 wells. All of the working plates are then sealed to prevent contamination and/or evaporation with an industry standard seal, such as a thermal heat seal from Velocity 11 or Porvair, and placed in a refrigerated compound storage area until needed to fill a customer order. These steps all fall within step 84 of FIG. 2.

In the preferred embodiment, customer orders for assay plates are received at a website running on a server operated by the assay provider operator. In the preferred embodiment, the customer order was generated using the methodology described in respect to FIG. 1, and includes information such as the chemical compounds to be used in the assay, the final test concentration and the well plate format. This information is entered into an automated software system (LIMS) which generates a work order to prepare the assay. In the preferred embodiment, the automated software comprises commercially available software such as the LIMS (laboratory information management) system available from Core Informatics.

The work order specifies which working plates should be retrieved based on the chemical compounds selected for the assay in the order, the configuration of the wells containing the chemicals (called the source plate map) as well as the configuration of empty (control) wells, if any, in the assay destination plate, as well as the type of well plate and any other items that should be used in the assay. A destination plate map is created defining the location of all chemical compounds and possible empty (control) wells in the assay plate. Identification and shipping information for the customer is also included in the work order. The working plates are then retrieved from storage and prepared for use such as by warming to room temperature, centrifuging the plates to ensure distribution of the source fluid in the wells of the working plate and removing the thermal seal from the working plates.

Two other important parameters in printing an assay are the final test volume and the final test concentration. The final test volume is the total volume (chemical plus solvent/reagent) in the well of the assay plate when the assay plate will be used by the customer. Typically, when the assay plate is printed, the aliquot volume is less than the final test volume, so the customer/end user will add a certain volume of solvent/reagent to the wells to reach the final test volume. The final test concentration is the concentration of the chemical compound in the final test volume. Since the aliquot volume is typically less than the final test volume, the concentration of the chemical compound in the printed assay plate (called the stock concentration) is typically greater than the final test concentration.

After the working plates and well plates for the assay have been prepared, the assay is printed. Printing the assay means that the chemical compounds selected for the assay by the customer are transferred from the working plates into the wells of the destination well plate selected for the assay. Preferably, a default or standard arrangement dispense map is used to print the assay plate, and the configuration of the chemicals in the wells (the assay plate map) is reported to the customer when the assay plate is shipped. Alternatively, the customer could specify an arrangement for the chemicals in the wells. For example, wells 1-4 are filled with chemical A, wells 5-8 are filled with chemical B, etc. A custom dispense map would be used in this situation to dispense the chemicals into the wells in the arrangement specified by the customer.

In order to print the assay, small volumes of the chemical compounds must be transferred from the wells in the working plates to the wells in the assay plates. In the preferred embodiment, the volume transferred from the wells in the working plates to the wells in the assay plates is as small as 10 picoliters (pL) or larger than 500 nL. Preferably, the volumes transferred from the working plates to the assay well plate are in the range of 10-250 nL, and more preferably are in the range of 15-100 nL. To accomplish these transfers, a very precise liquid transfer apparatus must be used. Additionally, as was discussed previously with respect to step 96, the number of transfers from the working plates to the assay plates can range from a hundred transfers to tens or hundreds of thousands or more transfers, and contamination must not be introduced during these transfers. Therefore, a machine is required to perform the dispensing operation involved in the printing of assays embodied in step 96.

In the preferred embodiment, the small volume dispenser is an acoustic liquid transfer device, such as the devices described in U.S. Pat. No. 6,596,239 or U.S. Pat. No. 6,863,362. These devices use acoustic energy to precisely dispense small volumes of the liquid and also have a multi-plate elevator for manipulating a plurality of working plates. The required working plates and their associated source plate map and assay plate map are loaded into the acoustic liquid transfer device which then automatically prints the assay plates. Other types of acoustic liquid transfer devices for use in step 96 are available commercially, such as the ATS-100 available from EDC Biosystems, Inc. of Milpitas, Calif.

After the assay plate (or plates) has been printed, the assay plate is preferably sealed in an argon environment, meaning that the assay plate is sealed in a humidity controlled atmosphere. This seals a layer of argon in place over the wells of the assay plate. In an optional step, the assay plate can be dried down prior to sealing, meaning that the carrier fluid the chemical compound is suspended in is allowed to evaporate. Thus, the chemical compound remains behind in the well as a thin film of compound on the bottom or side walls of the assay well plate.

After the assay plate has been printed and sealed, it is shipped to the customer. In the preferred embodiment, the assay plate is prepared for shipping by applying a bar code label to the assay plate that identifies the assay plate, and then sealing the assay plate in a moisture barrier bag that protects the assay plate from moisture. The assay plate is then placed in a cool pack which maintains the assay plate at a temperature below approximately 20° C., and the assay plate is shipped to the customer via an overnight delivery service. Other ways of preparing the assay plate for shipping could be used, and other types of shipping could be used. However, overnight shipment of the assay plate is greatly preferred.

Generally, a notice will be sent to the customer alerting them that the assay plate has been shipped. Preferably, the notice is sent via e-mail, but other forms of quick communication such as fax or voice message, etc. could be used to provide the notice. After receiving and unpacking the assay plate, the customer/end user backfills the wells in the assay plate with solvent/reagent to reach the desired final test concentration (if necessary). The assay plate is then ready for use in whatever way the customer/end user had planned for the assay.

In a preferred embodiment, the process illustrated in FIG. 2 can be described as a method for supplying a chemical assay substrate comprising the steps of receiving an order over the Internet for a chemical assay substrate that specifies a plurality of individual chemical compounds to be present on the chemical assay substrate (step 88); retrieving one or more working plates that contain the plurality of individual chemical compounds to be present on the chemical assay substrate, with each of the individual chemical compounds being held in a separate well on the one or more working plates (step 92); and transferring the plurality of individual chemical compounds from the one or more working plates to the chemical assay substrate in accordance with the order using an acoustic energy liquid dispensing apparatus (step 96).

FIG. 3 illustrates an apparatus used for processing an order for a chemical assay and for managing the inventory of chemical compounds that are available for use in the chemical assay. In the preferred embodiment, the end user uses an end user computer 120 to access the operator's website via the Internet (indicated by the arrow 122). The operator's website is running on the portal server 124. The website includes one or more order entry web pages that allow the end user to custom design and submit an order for a chemical assay plate, as was described previously with respect to FIG. 1. A database 130 stores a listing of all of the chemical compounds that the operator is making available for selection by the end user in designing the assay plate. The server 124 and a process control computer 134 are in electrical communication with the database 130.

A customer order submitted by the end user on the computer 120 is received on the server 124 and is transmitted to the process control computer 134. The customer order is then entered into a LIMS system running on the computer 134. The LIMS generates a work order which contains instructions and for retrieving one or more working plates containing the chemical compounds specified in the customer order. The work order also specifies what type of well plate should be retrieved to use as a substrate 146 for the assay, as well as any other supplies that will be needed, such as lids for the wells in the well plate.

The tube picker 138 is an optional unit that is used in situations where the stock concentrations of the chemicals are delivered to the operator from the supplier in industry standard tubes. Tubes range in size as to how much they can each hold (250 μL to 2000 μL). Typically, the tubes are supplied in a rack/holder. Each rack typically holds 96 tubes. However, there are some 384 tube configurations, but the storage volume of the tubes in this configuration drops significantly. The 96-tube configuration matches identically to a 96-well layout.

There are advantages and disadvantages to receiving stock concentration compounds in either 96-tube racks or 96-well plates. Well plates can be less expensive to purchase and are easier to seal/unseal. Tubes are more expensive, and are harder to seal, but, each tube can be individually bar coded and tracked. A well plate generally has only one bar code, so all compounds are pretty much tied to that bar code. Perhaps the biggest advantage to tubes is that each tube can be removed from its rack and placed into another rack. In other words, all the racks/tubes can be sorted. The tube picker 138 is a commercial device that can perform this function.

One commercially available system (REMP) comprises a tube storage device that can hold several thousand tubes. The storage device can have an optional tube sorter/picker. The REMP's database can keep track of the location of each individual tube/compound. When an order comes in for a series of compounds, the REMP system can pull all of the necessary racks and then “pick” only the tubes that are required. These tubes are then placed into an empty rack and this new rack is then presented to the operator for further processing. When the operator is finished with the new rack, the rack can be returned to the REMP system where the tubes can be re-sorted back to their original racks or left in the same new rack. The database is then updated with the new location of the compound. Despite these features, a drawback to using the REMP system is that it is slow and costly. Therefore, in the preferred embodiment, 96-well plates are used for the storage of stock concentration compounds received from the suppliers, so the tube picker 138 is not needed. As discussed earlier, these 96-well plates are reformatted into 1536 working plates, and then acoustic dispensing from the working plates into the end user's plate is performed.

The process control computer 134 also extracts a copy of the well map from the customer order, along with other well information such as the final liquid volume in the well and the final test concentration data. The well map and other well information are sent to a liquid dispenser 142. The working plates are loaded into the liquid dispenser 142 which prints the assay by dispensing the chemical compounds from the working plates into the wells of the well plate (substrate 146) according the well map and other well information. After the assay plate has been printed, it is processed for shipping as was described previously with respect to FIG. 2.

In a preferred embodiment, the apparatus illustrated in FIG. 3 can be described as an apparatus for supplying a chemical assay comprising a server means (124) for accepting a customer order transmitted to the server means over the Internet, the customer order specifying a plurality of chemical compounds to be used in a chemical assay. Order entry software for taking the customer's order, such as the software used to implement the process shown in FIG. 1, may also be provided to the on the server means. The apparatus also includes storage means (130) for electronically storing a list of chemical compounds available for inclusion in the customer order; process control means (134) for generating a work order that contains instructions for retrieving one or more working plates that contain the chemical compounds specified in the customer order for the chemical assay; and assay printing means (142) for dispensing the chemical compounds onto the assay substrate (146).

This invention enables user/customers, such as drug research scientists to design, assemble, and order (via the Internet) specific biochemical assay products from a number of biochemical content suppliers. These assay products (chemical compounds) are intended for drug discovery, compound efficacy, drug toxicity, protein-protein interaction, cell-based assays, rapid PCR (polymerase chain reaction), and RNAi (RNA interference) screens. The assay products are delivered to the scientists as ready-to-use, pre-dosed assays in industry-standard well plate formats with a removable seal structure. This invention enables the scientist, via the Internet portal, to search the multiplicity of content suppliers and their respective content databases to select only those chemical compounds that are of interest for their particular assay product(s).

The scientist or other end user can then order one or more of the custom-designed assay plates. The ability to order a single custom-designed assay plate comprised of thousands of chemicals, or more, including entire libraries of chemicals, is unique in the industry.

The invention provides a means for scientists to list, view and select chemical compounds from a multiplicity of compound suppliers. Provisions of the invention allow for a database that lists all available chemical compounds from each supplier (FIG. 1, step 24). The database can be sorted further in order to separate the compounds into logical families, groups, screen sets, etc. to aid the scientist in the selection process. The invention is further enhanced with built-in search/sort filters that allow the scientist to sort the chemical compounds by molecular properties, such as molecular weight and/or hydrogen bond donors or acceptors, thus drilling down to a specific, unique and individual compound (FIG. 1, step 28). Compounds may be selected individually (one-by-one), or by groups/families. Entire libraries from a single supplier may also be selected and ordered.

Furthermore, the invention allows for the scientist to specify other features and aspects of the assay product(s), such as the amount (volume) of biochemical to be assembled into the assay, the test concentration, and the containment structure (FIG. 1, steps 40, 44 and 48). Thus, the invention provides the end-user scientist the ability to configure a unique and custom assay product per their specification. Specifically, the invention provides a means for the scientist to list, view and select containment structures (typically industry-standard well plates) for which the chemical compounds are assembled upon. This enables the scientist to search and filter additional elements of the database by parameters such as well plate manufacturer, well plate material, well plate type (i.e. 96-well, 384-well, 1536-well, 3456-well types) and well volume.

Through the use of the Internet based storefront, the present invention allows the end user/scientist to order chemicals of their choosing and only in the amount (volume) that they need to run their particular assay. The invention provides a “ready-to-use” assay plate filled with the compounds of interest to the end user, pre-dosed for the concentration of the end user's choosing, plus in a configuration that best suits the end user's needs. Without the present invention, end users would need to order hundreds of microliters (μL) of a compound at 100-1000 times the concentration desired and then do all of the dilution and plate preparation work that the present invention provides to the end user.

Additionally, the invention provides a means for the scientist to specify locations within the containment structure as to where the biochemical compounds are to be located (FIG. 1, step 40), and the scientist can specify certain locations to remain blank or empty (FIG. 1, step 52). These locations can be utilized (filled) by the scientist at a latter date with additional chemical compounds.

Furthermore, these Internet-based storefront methodologies produce database instructions enabling the use of automated equipment that affords the novel ability to assemble these aforementioned customizable drug discovery screening type kits, such as homogeneous [i.e., TR-FRET (Time-Resolved Fluorescence—Fluorescence Resonance Energy Transfer) and AlphaScreen] and heterogeneous (i.e., ELISA, DELFIA), end-point kinetic or cell-based (i.e. proliferation, reporter, etc.) assays (ELISA is Enzyme-Linked ImmunoSorbent Assay and DELFIA is Dissociation-Enhanced Lanthanide Fluorescent Immunoassay).

Another aspect of the invention provides a means for a subsequent database to interact with and provide instructions for automated processing equipment, such as automated liquid handling and packaging equipment, to sort biochemical compounds, assemble the assay products, prepare the assay products for shipment, and subsequently, package the products. The invention also has provisions for integrating with traditional ERP/MRP/PDM business systems for the proper tracking and inventory management of all components used in the creation of the assay products, such as biochemicals, well plates, lids, labels, etc. MRN (material requirement planning) software is commercially available, as is ERP and PDM software.

Although the present invention has been described in terms of the presently preferred embodiments, it is to be understood that such disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention.

We claim:

1. A method for ordering a chemical assay plate comprising:
accessing an Internet based order entry site;
viewing a list of chemical compounds accessed from the order entry site, the list comprising a plurality of chemical compounds;
creating an order on the order entry site, the order being comprised of one or more assay compounds, the assay compounds comprising one or more chemical compounds selected from the list;
specifying a first well plate parameter in the order that specifies the number of wells in a well plate that will be used to hold the assay compounds;
specifying a second well plate parameter in the order that is related to the final test concentration for the assay compounds; and
placing the order from the order entry site.

2. The method of claim 1 wherein the second well plate parameter specifies that the final test concentration be in the range of 1 to 50 μM (micromolar).

3. The method of claim 1 further comprising specifying a third well plate parameter in the order that is related to the final test volume of a solution of at least one of the assay compounds in at least one of the wells.

4. The method of claim 1 wherein the number of wells in the well plate are selected from a group comprising 96 wells, 384 wells, 1536 wells and 3456 wells.

5. The method of claim 1 further comprising:
specifying a material from which the well plate is comprised.

6. The method of claim 1 further comprising:
specifying an empty well format that specifies one or more wells in the well plate that should be left empty.

7. The method of claim 1 further comprising:
filtering the list of chemical compounds accessed from the order entry site to select at least some of the assay compounds in the list.

8. A method for supplying a chemical assay substrate comprising:
receiving an order over the Internet for a chemical assay substrate that specifies a plurality of individual chemical compounds to be present on the chemical assay substrate;
retrieving one or more working plates that contain the plurality of individual chemical compounds to be present on the chemical assay substrate, with each of the individual chemical compounds being held in a separate well on the one or more working plates; and
transferring the plurality of individual chemical compounds from the one or more working plates to the chemical assay substrate in accordance with the order using an acoustic energy liquid dispensing apparatus.

9. The method of claim 8 wherein the order is received at a website.

10. The method of claim 8 wherein the chemical assay substrate is a well plate comprising a plurality of wells and the order specifies the number of wells in the well plate.

11. The method of claim 10 wherein the order specifies which wells in the well plate will contain each of the individual chemical compounds.

12. The method of claim 11 wherein the order specifies the final test concentration of the chemical compounds.

13. The method of claim 8 wherein the volume of at least one individual chemical compound transferred from the working plate to the chemical assay substrate is in the range of 15 nL to 100 nL.

14. The method of claim 8 wherein the volume of at least one individual chemical compound transferred from the working plate to the chemical assay substrate is in the range of 10 nL to 250 nL.

15. The method of claim 8 further comprising:
shipping the chemical assay substrate to a specified address sometime after the plurality of individual chemical compounds have been transferred to the chemical assay substrate.

16. The method of claim 8 wherein the plurality of individual chemical compounds comprise materials that are used in screening assays for drug discovery, compound efficacy, drug toxicity, protein-protein interaction, cell-based assays, rapid PCR (polymerase chain reaction) assays and RNAi (RNA interference) screens.

17. The method of claim 8 wherein the plurality of individual chemical compounds comprises more than 6500 separate chemical compounds.

18. An apparatus for supplying a chemical assay comprising:
server means for accepting a customer order transmitted to the server means over the Internet, the customer order specifying a plurality of chemical compounds to be used in a chemical assay;
storage means for electronically storing a list of chemical compounds available for inclusion in the customer order;
process control means for generating a work order which contains instructions for retrieving one or more working plates that contain the chemical compounds specified in the customer order for the chemical assay; and
assay printing means for dispensing the chemical compounds onto the assay substrate.

19. The apparatus of claim 18 wherein assay printing means comprises an acoustic liquid dispensing apparatus that uses acoustic energy to dispense the chemical compounds.

20. The apparatus of claim 19 wherein the acoustic liquid dispensing apparatus dispenses the chemical compounds in volumes in the range of 10 nL to 250 nL.
